(19) United States
(12) Patent Application Publication
(10) Pub. No.: US 2016/0159572 A1
(43) Pub. Date: Jun. 9, 2016

(54) Recycling and Garbage Chute Assembly

(71) Applicant: Louise Prewitt, Warren, MI (US)

(72) Inventor: Louise Prewitt, Warren, MI (US)

(21) Appl. No.: 14/957,766

(22) Filed: Dec. 3, 2015

Related U.S. Application Data
(60) Provisional application No. 62/087,302, filed on Dec. 4, 2014.

(51) Int. Cl. B65G 11/02; B65G 11/20

(52) U.S. Cl. CPC B65G 11/023; B65G 11/206; B65G 11/203

(57) ABSTRACT

A recycling and garbage chute assembly for preventing odors from permeating throughout the interior of a building caused by an accumulation of recyclables and garbage. The recycling and garbage chute assembly includes a plurality of interior cabinets that can be disposed within a kitchen or other area in a building. Each interior cabinet houses a bin having an open upper and lower end, wherein the upper end of the bin receives garbage or recyclables therethrough. A chute is secured to an opening in a rear wall of each interior cabinet, wherein each chute leads to an exterior container that can receive the recyclables or garbage therein. As the bin is temporarily moved into the chute, the recyclables and garbage fall through the lower end of the bin, through the chute, and into the exterior container. Each chute can be installed through an exterior wall of a building.

### CROSS REFERENCE TO RELATED APPLICATION

This application claims the benefit of U.S. Provisional Application No. 62/087,302 filed on Dec. 4, 2014. The above identified patent application is herein incorporated by reference in its entirety to provide continuity of disclosure.

### BACKGROUND OF THE INVENTION

The present invention relates to garbage removal assemblies. More specifically, the present invention provides a recycling and garbage chute assembly for recycling and disposing of garbage so as to prevent clutter and odors from permeating throughout the interior of a building.

Many people accumulate waste, such as garbage and recyclables, throughout the week that must be properly disposed of by way of weekly waste management services or the like. Until it is time for waste management to pick up the waste, some individuals store their garbage and recyclables in a kitchen or nearby room, which leads to foul odors and clutter accumulation indoors. Others choose to take recyclables and garbage outdoors once a disposable bag or recycling bin that is kept indoors has been completely filled. However, leaving waste having remnants of food thereon indoors overnight or throughout the day will likely attract bugs and rodents, in addition to allowing odors to emanate through a household or business.

Further, the types of material of containers and other products that can be recycled, as opposed to being tossed directly in the garbage or landfill, has increased due to advances in recycling technology. Additionally, there is an increase in the amount of containers that can be recycled due to the desire for individual sized packaging contained within larger packages. However, some waste management service providers require garbage and different recyclable materials to be sorted and separated in order to be properly and efficiently recycled. Therefore, there is a need for an assembly that allows a user to prevent waste, such as garbage and recyclables, from accumulating indoors and allows the waste to be conveniently separated, thereby providing a means for promoting recycling.

Devices have been disclosed in the prior art that relate to garbage removal or sorting assemblies. These include devices that have been patented and published in patent application publications. These devices generally relate to waste separating containers, such as U.S. Pat. No. 2,792,171, U.S. Pat. No. 8,474,591, U.S. Pat. No. 5,275,522, U.S. Pat. No. 4,974,746, U.S. Pat. No. 5,119,958, U.S. Pat. No. 5,873,643, and U.S. Pat. No. 6,119,869.

These prior art devices have several known drawbacks. Some devices in the prior art provide a single chute configured to receive garbage via a door secured to an upper end of the chute, wherein the garbage moves down the chute once the door is closed. In the present invention, garbage and recyclables are disposed through an interior cabinet and into a bin within the cabinet, wherein the bin includes an open lower end that can be temporarily aligned with a chute, thereby disposing of the waste into an exterior container. Further, the prior art fails to provide a plurality of chutes, bins, interior cabinets, and exterior containers interconnected so as to allow for the sorting and separating of garbage and various types of recyclables. Other devices in the prior art provide containers having different compartments for separating waste, however, such devices fail to provide an external chute configured to be disposed within a wall of a building.

In light of the devices disclosed in the prior art, it is submitted that the present invention substantially diverges in design elements from the prior art and consequently it is clear that there is a need in the art for an improvement to existing garbage removal assemblies. In this regard the instant invention substantially fulfills these needs.

### SUMMARY OF THE INVENTION

In view of the foregoing disadvantages inherent in the known types of recycling and garbage chute assemblies now present in the prior art, the present invention provides a new recycling and garbage chute assembly wherein the same can be utilized for providing convenience for the user when preventing odors from permeating an interior of a building caused by an accumulation of recyclables and garbage

The recycling and garbage chute assembly includes a plurality of interior cabinets that can be disposed within a kitchen or other area in a building. Each interior cabinet houses a bin having an open upper and lower end, wherein the upper end of the bin receives garbage or recyclables therethrough. A chute is secured to an opening in a rear wall of each interior cabinet, wherein each chute leads to an exterior container that can receive the recyclables and garbage therein. As the bin is temporarily moved into the chute, the recyclables and garbage fall through the lower end of the bin, through the chute, and into the exterior container. Each chute is configured to be installed through a wall of a building, thereby providing access form the interior of the building to the exterior thereof.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the interior cabinets of the recycling and garbage chute assembly.

FIG. 2 shows a perspective view of the bin of the recycling and garbage chute assembly.

FIG. 3 shows a perspective view of the exterior container of the recycling and garbage chute assembly.

FIG. 4A shows a cross sectional view of the chute of the recycling and garbage chute assembly wherein the lid is closed.

FIG. 4B shows a cross sectional view of the chute of the recycling and garbage chute assembly wherein the lid is open.

FIG. 5 shows a cross sectional view of the recycling and garbage chute assembly.

### DETAILED DESCRIPTION OF THE INVENTION

Reference is made herein to the attached drawings. Like reference numerals are used throughout the drawings to depict like or similar elements of the recycling and garbage chute assembly. For the purposes of presenting a brief and clear description of the present invention, the preferred embodiment will be discussed as used for preventing odors from permeating an interior of a building caused by an accumulation of recyclables and garbage. The figures are intended for representative purposes only and should not be considered to be limiting in any respect.

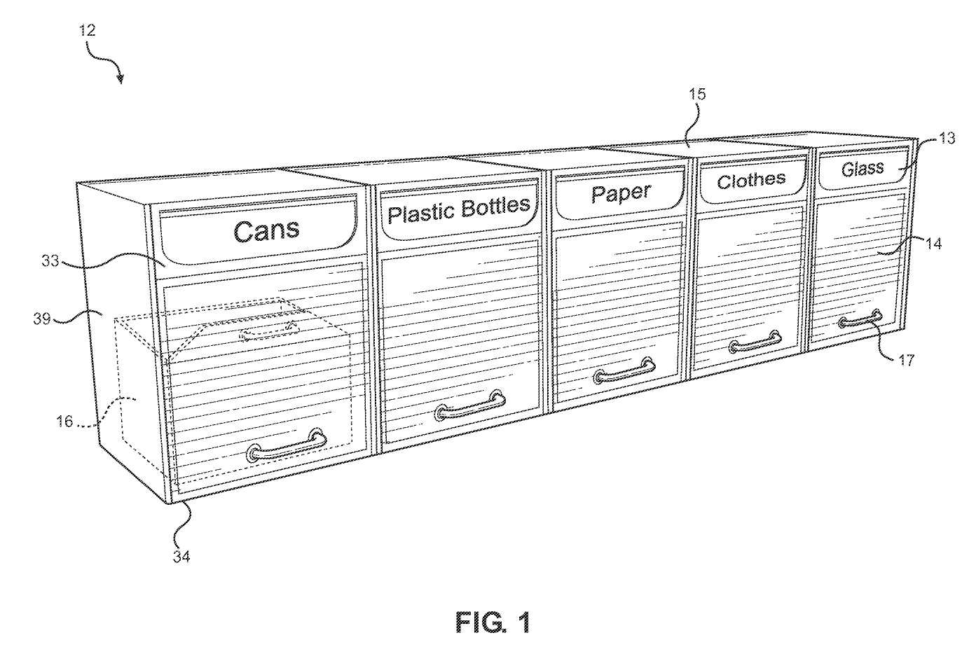

Referring now to FIG. 1, there is shown a perspective view of the interior cabinets of the recycling and garbage chute assembly. The assembly comprises a plurality of interior cabinets 12 connected to one another via a shared or connecting wall. The interior cabinets 12 are configured to be disposed within an interior of a building, such as a kitchen or other nearby room, wherein each cabinet 12 houses a bin 16 therein. The bins 16 are configured for receiving waste, such as recyclables and garbage. A chute is connected to each interior cabinet and disposed through the wall of the building. The chute is configured to transport waste from the bin 16 to an exterior container disposed on the exterior of the building.

Each interior cabinet 12 comprises a base 34, one or more sidewalls 32, and an upper wall 15, defining an interior volume. Preferably, the interior cabinets 12 are connected to one another in a row via a shared sidewall 39 or having a sidewall 39 of a first interior cabinet 12 secured flush against a sidewall 39 of a second interior cabinet 12, such that a front wall 33 of all the interior cabinets are facing the same direction. In the illustrated embodiment, the interior cabinets 12 comprise a rectangular cross section, wherein each cabinet 12 includes a front wall 33 and a rear wall. Preferably, the rear wall is adapted to be positioned flush against a wall of the interior of the building so as to prevent the cabinets 12 from creating an obstacle within the room. A first opening is disposed on a lower end of the front wall 33 and a second opening is disposed on the upper end thereof. Each opening is removably covered by a door 13, 14 pivotally secured to the interior cabinet 12, wherein the doors 13, 14 conceal the bins 16 within the interior volume. In some embodiments, the door 14 pivotally secured to the first opening comprises handles 17 thereon for allowing a user to lift the door 14 to an open position. Whereas, in the illustrated embodiment, the door 13 pivotally secured to the second opening is configured to pivot inwards.

The first opening provides access to the interior volume of the cabinet 12 in order to allow a user to temporarily move the bin 16 within the chute when the user is ready to transport the waste from the interior of the building to the exterior of the building. The second opening provides access to the interior volume of the cabinet 12, above the bin 16, so as to allow waste to be conveniently disposed of within the bin, similar to a conventional trash receptacle. A rear opening is disposed on the rear wall of the cabinet 12 in order to provide access from the interior volume of the cabinet 12 to an exterior of a building via the chute.

Preferably, the exterior of each interior cabinet 12 comprises a label indicating the type of waste in which the cabinet 12 is configured to receive. For example, a first interior cabinet 12 comprises a label indicating “cans” and a second cabinet 12 includes a label indicating “plastic bottles”, such that only waste material composed of plastic should be received by the second cabinet 12. In this way, a user is able to sort and separate his or her waste by the type of recyclable material. Further, in some embodiments, the recycling and garbage chute assembly is configured to provide for an interior cabinet labeled as “garbage” so as to allow for conventional garbage to be disposed therein as well.

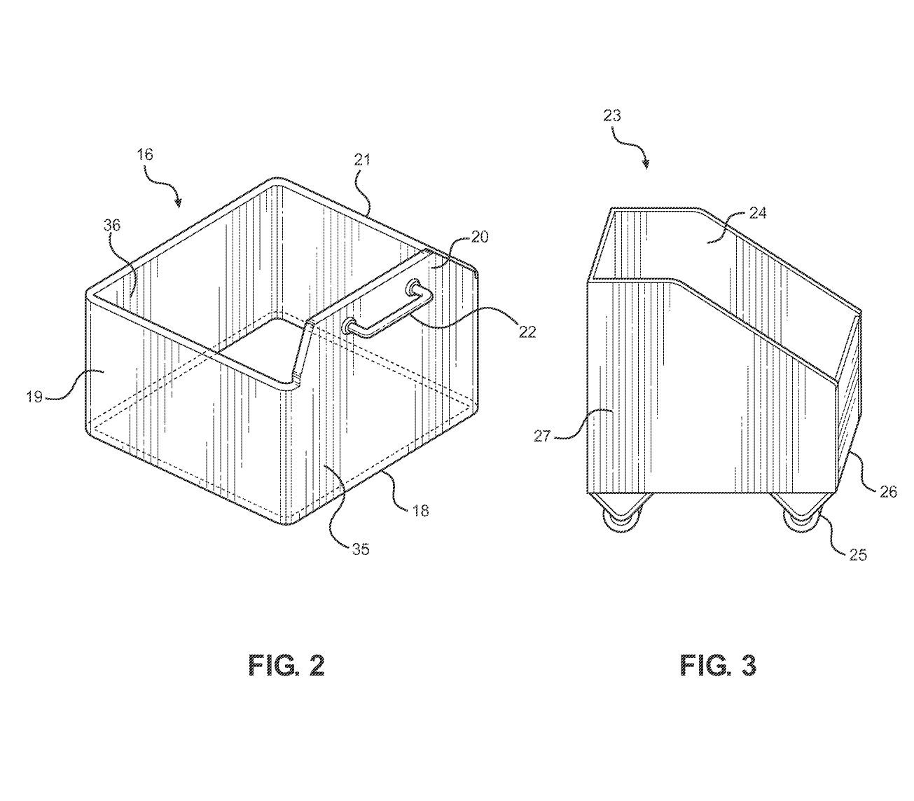

Referring now to FIG. 2, there is shown a perspective view of the bin of the recycling and garbage chute assembly. Each bin 16 comprises an open lower end 18, one or more sidewalls 19, and an open upper end 21, defining an interior volume. The open upper end 21 is configured to receive waste therethrough, whereas the open lower end 18 allows the waste to pass therethrough and into the chute when the bin 16 is positioned within the chute. Once waste is disposed into a bin 16, the waste rests on the base of the interior cabinet until a user desires to empty the bin 16 by moving the open lower end 18 of the bin 16 into the chute. A front end 35 of the bin 16 is used to push the waste towards the chute. In some embodiments, a handle 22 is disposed on a sidewall 19 in order to allow the bin 16 to be conveniently maneuvered by a user.

In the illustrated embodiment, the bins 16 comprise a rectangular shape, having a front wall 35 and a rear wall 36, so as to fit within the interior volume of an interior cabinet. The front wall 35 of the bins 16 comprise a vertical member 20 that extends upwards therefrom and is configured to prevent the bin 16 from fitting through the rear opening of the interior cabinet and into the chute. Thus, the front wall 35 of the bin 16 is larger than that of the rear opening. As the bin 16 is temporarily moved into the chute for disposal of the waste, all but the front wall 35 of the bin 16 is configured to fit in the chute. In other embodiments, other protrusions or barriers may be disposed on various locations on the bin 16 in order to prevent the bin from passing through the chute at a particular point.

Referring now to FIG. 3, there is shown a perspective view of the exterior container of the recycling and garbage chute assembly. In some embodiments, the recycling and garbage chute assembly comprises a plurality of exterior containers 23. Each exterior container 23 is configured to be positioned on the exterior of the building and beneath a chute so as to receive the particular waste from the corresponding bin. The exterior containers 23 comprise a base 26, one or more sidewalls 27, and an open upper end 24, defining an interior volume. In some embodiments, the base 26 comprises one or more wheels 25 so as to allow a user to conveniently maneuver the exterior container 23 to a curb or other area for waste pick up. In the illustrated embodiment, the exterior container 23 comprises a cross section having a rectangular shape. However, in other embodiments, the exterior container may comprise any suitable shape. In some embodiments, the chute is removably secured to the upper end of the container by any suitable fastener, such as clips. This allows the exterior container 23 and corresponding chute to remain in position until the exterior container 23 is detached from the chute for waste removal therefrom.

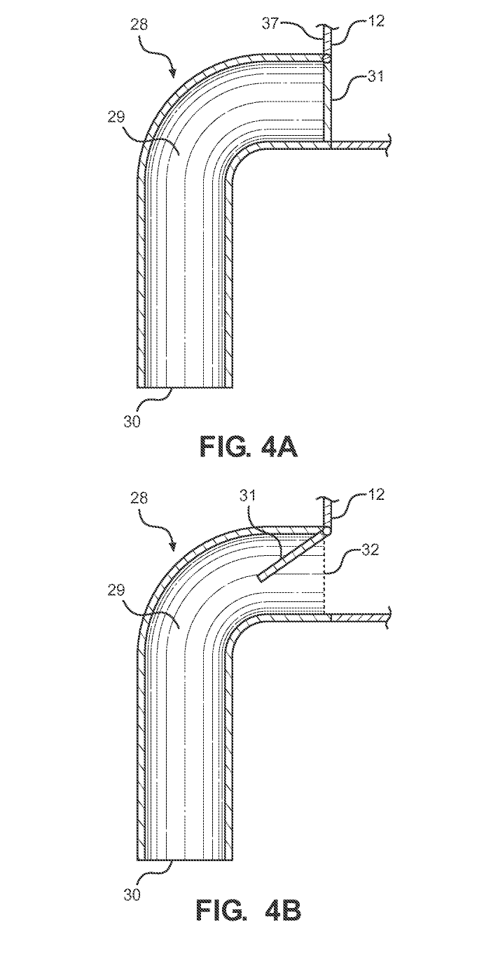

Referring now to FIGS. 4A and 4B, there are shown cross sectional views of the chute of the recycling and garbage chute assembly. A chute 28 is attached to the rear wall 37 of each interior cabinet 12 over the rear opening 32 thereof via any suitable fastener, such as screws. Each chute 28 includes an open upper end and an open lower end 30, thereby forming a channel 29 therethrough. The upper end extends horizontally and outwards from the rear wall 37 of the interior cabinet 12 and the lower end extends downward therefrom, wherein the open lower end 30 is disposed over the exterior container so as to allow waste to be released therein. The lower end of the chute 28 is vertical or sloped so as to allow waste to fall via gravity into an exterior container. Thus, the exterior container is positioned at a lower elevation than the interior cabinet and chute 28 so as to receive the waste via gravity. Preferably, the chute 28 comprises a cross section having a rectangular shape. The chute 28 is adapted to be disposed through a wall of a building so as to connect the interior cabinet 12 to the exterior container.

A lid 31 is pivotally secured over the open upper end of the chute 28 so as to seal the interior of the building from the exterior thereof. In a closed position, the lid 31 covers the open upper end and creates a seal therearound via a gasket or similar seal. In some embodiments, one or more magnets are disposed around the periphery of the upper end of the chute 28 and the lid 31 so as to removably secure the lid 31 thereto. As the bin is moved through the open upper end of the chute 28, the lid 31 is manually lifted towards the interior of the chute 28, temporarily breaking the seal and allowing the waste from the bin to pass into the chute 28. The lid 31 prevents unwanted odors and rodents from traveling up the chute 28 from the open lower end 30 and into the interior cabinet 12 in which the chute 28 is connected.

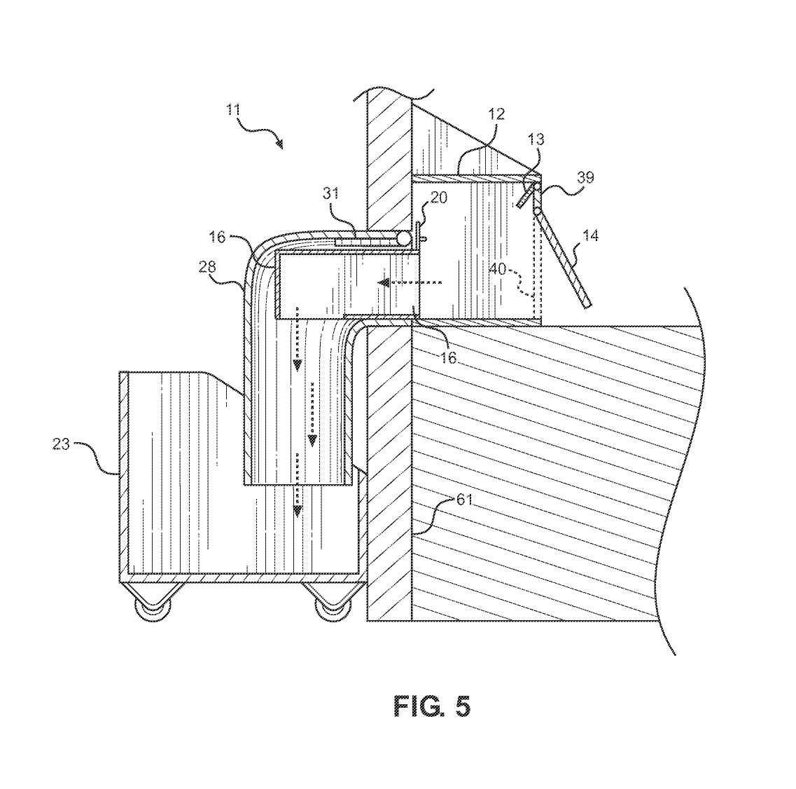

Referring now to FIG. 5, there is shown a cross sectional view of the recycling and garbage chute assembly. The interior cabinets 12 are positioned within a kitchen or nearby room and the chute 28 extends through a wall 61 thereof to the outside of the building so that the waste is positioned outside of the home in order to avoid odors from permeating throughout the building. In operation, a bin 16 is disposed within the interior volume of each interior cabinet 12. Recyclables are disposed through the second opening 39 on the front wall of the cabinet. Once a user desires to dispose of the waste outside, the user lifts the door 14 covering the first opening 40 and temporarily moves the bin 16 through the upper end of the chute 28, thereby causing the lid 31 of the chute 28 to lift. As the open lower end of the bin 16 is positioned within the chute 28, the waste falls through the chute 28 and into the exterior container 23. The bin 16 is returned to the interior volume of the interior cabinet 12, wherein the lid 31 is closed so as to seal the inside of the building from the outside.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A recycling and garbage chute assembly, comprising:
a plurality of interior cabinets each having a base, one or more sidewalls, an upper wall, a first opening providing access to an interior volume from an interior of a building, and a rear opening providing access from the interior volume to an exterior of a building, wherein each of the plurality of interior cabinets is configured to house and conceal a bin therein;
A plurality of bins disposed in the plurality of interior cabinets, wherein each of the plurality of bins comprise an open lower end, an open upper end, and one or more sidewalls extending therebetween and configured to receive waste therein via the open upper end;
a plurality of chutes, wherein one chute is affixed to the rear opening of each of the plurality of interior cabinets.

2) The recycling and garbage chute assembly of claim 1, wherein each of the plurality of interior cabinets are connected to one another in a row, wherein a sidewall of a first interior cabinet is secured to a sidewall of a second interior cabinet.

3) The recycling and garbage chute assembly of claim 1, wherein the first opening is removably covered by a first door pivotally secured to the interior cabinet so as to conceal the plurality of bins.

4) The recycling and garbage chute assembly of claim 1, further comprising a second opening disposed on the front wall of the plurality of interior cabinets, above the first opening, wherein the second opening is removably covered by a second door pivotally secured to the interior cabinet so as to allow the recycling or garbage to be disposed of into the plurality of bins.

5) The recycling and garbage chute assembly of claim 1, further comprising a plurality of exterior containers each having a base, one or more sidewalls, defining an interior volume, and an opening configured to receive the recycling or garbage from the plurality of bins.

6) The recycling and garbage chute assembly of claim 1, wherein the chute comprises a lid pivotally secured to an upper end thereof and removably covers the rear opening of the plurality of interior containers so as to seal the interior of a building from the exterior of the building.

7) The recycling and garbage chute assembly of claim 6, wherein the periphery of the lid comprises a seal thereon so as to create a seal between the lid and a periphery of the rear opening of the plurality of interior containers.

8) The recycling and garbage chute assembly of claim 1, wherein the plurality of interior cabinets comprise a cross section having a rectangular shape.

9) The recycling and garbage chute assembly of claim 1, wherein the plurality of bins comprise a cross section having a rectangular shape.

10) The recycling and garbage chute assembly of claim 1, wherein each of the plurality of bins comprise a vertical member extending upwards from the one or more sidewalls thereof so as to prevent each of the plurality of bins from fitting through the rear opening of the plurality of interior cabinets.

11) The recycling and garbage chute assembly of claim 1, wherein one of the plurality of bins is disposed in one of the plurality of interior cabinets.
